(19) United States
(12) Patent Application Publication
(10) Pub. No.: US 2002/0116084 A1
(43) Pub. Date: Aug. 22, 2002

(54) Method and system for qualifying and controlling supplier test processes

(76) Inventor: Robert V. Falsetti, Schenectady, NY (US)

Correspondence Address: PERKINS COIE LLP, PATENT-SEA, P.O. BOX 1247, SEATTLE, WA, 98111-1247, US

(21) Appl. No.: 09/740,724

(22) Filed: Dec. 18, 2000

(51) Int. Cl. G06F 19/00

(52) U.S. Cl. 700/109; 700/108; 700/110

(57) ABSTRACT

A method and system for quantitatively qualifying and controlling a component supplier's non-destructive test (NDT) processes. In one embodiment, the method quantitatively determines a supplier rating in three separate NDT process control areas: (1) personnel qualification, (2) process audits, and (3) reliability of the inspection technique. Successively higher supplier ratings in these NDT process control areas can be attained by exercising progressively more rigorous NDT practices in the applicable control area, or by increased buyer oversight in the applicable control area. The individual supplier ratings in these separate NDT process control areas can also be combined to produce an overall rating of the suppliers NDT processes referred to as the Inspection Quality Rating (IQR). The sufficiency of a supplier's NDT processes can then be readily determined by referring to either the supplier's IQR or, if greater detail is required, by referring to the supplier's individual ratings in the separate NDT process control areas.

### TECHNICAL FIELD

The described technology relates to qualification of supplier test processes, and more particularly, to methods and systems for quantitative qualification and control of supplier non-destructive test processes.

### BACKGROUND

Equipment manufacturers typically rely on outside suppliers to provide at least some of the raw materials or components that go into the assembly of their products. When manufacturers procure components from outside suppliers they need to be assured that the components will conform to all of the applicable engineering requirements. One way to assure that a component will conform to its engineering requirements is to require the component supplier to subject the component to a series of comprehensive non-destructive acceptance tests. In today's competitive business environment, however, many suppliers are changing or eliminating steps in their manufacturing processes and in their non-destructive test programs in an effort to reduce costs. Unfortunately, many of the changes being made to reduce cost may also reduce the quality of the component as well as buyer confidence in the results of non-destructive tests.

In an effort to avoid buying non-conforming components, equipment manufacturers will often attempt to qualify certain component suppliers based on the suppliers' non-destructive test (NDT) processes. Some NDT processes, however, are inherently more reliable than others due to the unique inspection techniques used or the degree of computer control in the process. In addition, because not all components require the same level of NDT inspection, some suppliers may be qualified to produce some components and not others. Conventional methods for qualifying suppliers, however, are not quantitative in nature and do not provide the buyer with a way to differentiate between supplier NDT processes based on these factors. Moreover, conventional methods for qualifying component suppliers typically do not provide the buyer with a way to specify differing levels of NDT process qualification depending on the specific engineering requirements of the component in question. As a result, conventional methods for qualifying suppliers based on NDT processes can be somewhat subjective and inconsistent, resulting in procurement of equally inconsistent components.

Current industry practice among component buyers is to separate the NDT process qualification requirements into general categories without consideration of how these categories interact to control the entire inspection process. For example, NDT process qualification requirements can be separated into the general categories of personnel qualifications, facility audits, and inspection reliability. Suppliers are then required to maintain certain minimum qualifications in each of the categories. Beyond this, however, no information is sought regarding the actual extent of a supplier's capability in each of the categories. One result of this simplified approach to supplier qualification is that component buyers often experience difficulty determining which suppliers are qualified to meet specific engineering requirements with respect to one of the categories, and consequently resources are needlessly expended rejecting non-conforming components procured from unqualified suppliers.

The current industry practice has the further disadvantage of requiring component suppliers to expend the resources necessary to maintain certain minimum levels of NDT qualification in all three general categories. In light of the foregoing, a method for qualifying a supplier's NDT processes that provides a buyer with the ability to consistently procure acceptable components, and in turn enables the supplier to achieve and maintain the required level of qualification in a cost-effective way, would be desirable.

### BRIEF DESCRIPTION OF THE DRAWINGS

FIG. 1 is a flow diagram of a routine for calculating a supplier's Inspection Quality Rating in one embodiment.

FIG. 2 is a diagram illustrating an audit form for a practical examination of a supplier's inspection process in one embodiment.

FIG. 3 is a flow diagram of a routine for calculating a supplier's grade on the practical examination of the supplier's inspection process in one embodiment.

FIG. 4 is a diagram illustrating a checklist that can be used to review and approve a supplier's quality system in one embodiment.

FIG. 5 is a flow diagram of a routine for reviewing and approving a supplier's quality system in one embodiment.

FIG. 6 is a block diagram illustrating a computer system that can be used to determine NDT process control area ratings and a corresponding Inspection Quality Rating in one embodiment.

FIG. 7 is a diagram illustrating one possible array of acceptable combinations of Degree of Quality, Degree of Audit, and Degree of Reliability in one embodiment.

### DETAILED DESCRIPTION

A method and system is provided to quantitatively qualify and control a component supplier's non-destructive test (NDT) processes. In one embodiment, the method provides a system for quantitatively determining a supplier rating in three separate NDT process control areas: (1) personnel qualification, (2) process audits, and (3) reliability of the inspection technique. Supplier ratings in each of these NDT process control areas are determined using objective scales containing three or more possible ratings. The supplier rating in the NDT process control area of personnel qualification is referred to as the Degree of Qualification (DQ), the supplier rating in the control area of process audits is referred to as the Degree of Audit (DA), and the supplier rating in the control area of reliability of the inspection technique is referred to as the Degree of Reliability (DR). Successively higher values of DQ, DA, and DR can be attained by the supplier by exercising progressively more rigorous NDT practices in the applicable control area, or by increasing buyer oversight in the applicable control area. Accordingly, a relatively high score of DQ, DA, or DR quantitatively corresponds to a high level of confidence in the supplier's NDT processes corresponding to the respective control area.

The individual supplier ratings of DQ, DA, and DR corresponding to the three separate NDT process control areas can be combined in accordance with an embodiment to produce an overall rating of the supplier's NDT processes referred to as the Inspection Quality Rating (IQR). Accordingly, a relatively high IQR score quantitatively corresponds to a high level of confidence in the supplier's overall NDT processes. As an example of one embodiment of the methods described herein, a supplier might receive a DQ rating of 7 in the area of personnel qualification, a DA rating of 5 in the area of process audit, and a DR rating of 6 in the area of reliability of inspection technique, for an overall IQR of 18. A buyer could now readily determine the sufficiency of the supplier's NDT processes by referring to either the supplier's overall IQR or, if greater detail is required, by referring to the supplier's individual DQ, DA, and DR ratings.

By using a quantitative rating system, the method ensures consistent application of supplier qualification practices and consistent procurement of satisfactory components. The method further provides the component buyer with a useful mechanism for selecting the degree of control desired for a component NDT process by specifing an IQR on the drawing or in the material specification. The buyer can additionally specify a DQ, DA or DR where further refinement of control is needed. Breaking the IQR down into three separate control areas also affords the component supplier the flexibility to achieve and maintain the required level of IQR in the most timely and cost-effective way by selectively emphasizing those control areas which most cost-effectively increase the IQR. For example, the supplier might elect to increase the level of DQ while concurrently letting the level of DA fall, thereby maintaining a constant IQR. Of course, if the buyer has specified the required confidence level associated with a particular control area then the supplier will not have the flexibility to vary the emphasis on that control area.

Although the following enabling description provides specific details for a thorough understanding of several embodiments of the Inspection Quality Rating (IQR) with reference to the Degree of Qualification (DQ), the Degree of Reliability (DA), and the Degree of Reliability (DR), one of skill in the relevant art will understand that these embodiments can be practiced without some of these details. In other instances, one skilled in the art will appreciate that the IQR can include additional details relating to additional control areas where dictated by the needs of the buyer or the component concerned. Further, certain embodiments of the methods disclosed herein will be described in the general context of computer-executable instructions, such as routines executed by a general-purpose computer. The well-known structures and functions related to computer-executable instructions and corresponding computer implementation systems have not been shown or described in detail to avoid unnecessarily obscuring the description of the embodiments. As those skilled in the art will appreciate, however, embodiments can be practiced with other computational devices or distributed computer networks, or alternatively, with manual computations.

The Inspection Quality Rating (IQR) for a given supplier is calculated in one embodiment using equation (1) below:

IQR=DQ+DA+DR (1)

The IQR in equation (1) is a number from zero to 18 in one embodiment. A relatively high IQR number implies that the supplier maintains high standards for inspection practices, and thus a buyer can have a relatively high level of confidence in the supplier's reported inspection results. The Degree of Qualification (DQ) is a number on a scale of zero to five that is based on a level of verification used to determine a supplier's initial ability to perform the NDT inspections in accordance with the buyer's process specification. The Degree of Audit (DA) is a number on a scale of zero to seven that is based on the level of control used to verify a supplier's performance to the buyer's process specification. The Degree of Reliability (DR) is a number on a scale of zero to six that is based on the level of control exercised by the supplier when performing the NDT inspections, or alternatively, is based on the inherent reliability of the inspection modality used by the supplier. One skilled in the art will appreciate that the number ranges presented above for the IQR, DQ, DA, and DR represent only one embodiment of the method and can vary accordingly depending on the degree of refinement desired or the relative importance of the different terms. One skilled in the art will also appreciate that the numbers assigned to the DQ, DA, and DR can also vary depending on the relative importance that a buyer places on each.

In other embodiments, it may be desirable to assign different weights to the respective values of DQ, DA, and DR where a particular buyer desires an NDT process with increased emphasis in one control area and less in others. Equation (2) below provides a method for calculating an IQR in accordance with such an embodiment:

IQR=W₁·DQ+W₂·DA+W₃·DR (2)

In equation (2), W₁-W₃ are weighting factors. If, for example, a particular buyer desired increased emphasis in the area of personnel qualification corresponding to DQ, and less emphasis in the areas of process audits and reliability of inspection techniques, corresponding to DA and DR, respectively, then W₁ could be a weighting factor of 2 and W₂ and W₃ could both be weighting factors of 0.5. In other embodiments, W₁-W₃ can be other weighting factors depending on the relative weighting that a buyer chooses to assign to a particular area based on the buyer's needs. This embodiment may be particularly useful when the values of DQ, DA and DR are determined by an independent third party and provided to a buyer. In this scenario, the buyer can use equation (2) with appropriate weighting factors to obtain an IQR that reflects the buyer's particular NDT criteria. In accordance with the foregoing discussion, it will be appreciated by those of skill in the art that the utility of the methods and systems described herein are not limited to the embodiments of equations (1) and (2), but in fact can be tailored to a specific buyer in multiple ways without departing from the scope or intent of the present disclosure.

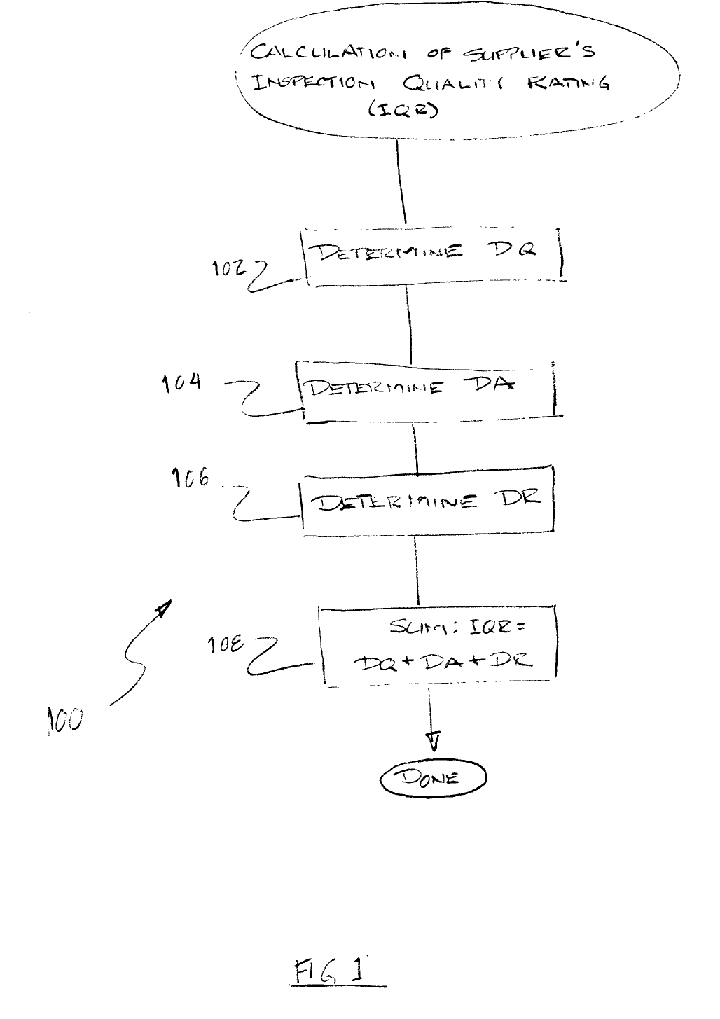

FIG. 1 is a flow diagram of a routine 100 for calculating a supplier's inspection quality rating (IQR) in accordance with an embodiment. In one aspect of this embodiment, the routine 100 can be implemented on a suitable computer system using appropriate computer-executable instructions embedded on a computer-readable medium. In block 102, the routine 100 determines a Degree of Qualification (DQ).

As mentioned above, in one embodiment the DQ is a number on a scale of zero to five that is based on a level of verification used to determine a supplier's initial ability to perform the NDT inspections in accordance with the buyer's process specification. Higher numbers for the DQ imply a greater degree of confidence in the supplier's ability to perform the related inspections in accordance with the process specification. In one aspect of this embodiment, the requirements that a supplier has to meet in order to achieve a particular DQ rating are shown below in Table 1.

TABLE 1
DQ = 0, No evidence of supplier qualification is submitted.
DQ = 1, Supplier submits evidence of a valid and current certification
from the National Aerospace and Defense Contractors Accreditation
Program (NADCAP), another buyer business, or a government agency.
DQ = 2, Supplier submits an inspection procedure, technique
sheet(s), training records, examination records and written
practice for qualification and certification of nondestructive
testing personnel to buyer for approval. The inspection procedure
and technique sheets are signed by the supplier’s level III
and the buyer’s level III.
DQ = 3, In addition to the requirement for DQ = 2, buyer
examines and certifies supplier’s level III by administering a
general, specific and practical examination at a location other
than the supplier’s inspection facility. The general test may be
waived if the supplier’s level iii supplies evidence of
certification from a central agency that administers a general
examination as part of its certification program. Buyer reviews
and approves the supplier’s quality system using a checklist.
DQ = 4, In addition to the requirement for DQ = 3, buyer
examines and certifies supplier’s level III by administering a
general, specific and practical examination at the supplier’s
inspection facility. The supplier’s level III may receive
assistance from a level II for operation of equipment and
collection of inspection data during the practical examination.
DQ = 5, In addition to the requirement for DQ = 4,
buyer examines and certifies all of the applicable inspectors
by administering a general, specific and practical examination
at the supplier’s inspection facility. The general test may
be waived if the inspectors supply evidence of certification
from a central agency that administers a general examination
as part of its certification program.

In other embodiments, other criteria can be established for achieving different DQ ratings depending on the particular needs of the buyer or the nature of the component being procured.

Most of the requirements to achieve the various DQ ratings shown in Table 1 are self-explanatory and will be readily understood by those of skill in the art. Some of the requirements, however, may benefit from further explication. For example, to achieve a DQ=2, the supplier must submit, among other things, an “inspection procedure” and a “technique sheet.” An inspection procedure may be defmed as a document prepared by the supplier that provides a detailed description of the supplier's inspection process. This procedure should identify the specific test equipment, instrument settings, step-by-step operating instructions, and the test result reporting and acceptance criteria. A technique sheet can be a one-page summary sheet that provides detailed inspection information for each component according to drawing number or component geometry.

Also in Table 1, the reference to the “Supplier's level III” and the “Buyer's level III” at various places refers to inspection personnel at the respective buyer and supplier facilities who possess the requisite qualifications for the Level III title. These qualifications have been defined by the American Society of Nondestructive Testing (ASNT) as follows: An NDT Level III individual is capable of establishing techniques and procedures; interpreting codes, standards, specifications, and procedures; and designating the particular NDT methods, techniques, and procedures to be used. The NDT Level III is responsible for the NDT operations for which qualified and assigned and is capable of interpreting and evaluating results in terms of codes, standards, and specifications. The NDT Level III has sufficient practical background in applicable materials, fabrication, and product technology to establish techniques and to assist in establishing acceptance criteria when none are otherwise available. The NDT Level III has general familiarity with other appropriate NDT methods, as demonstrated by the ASNT Level III Basic examination or other means. The NDT Level III, in the methods in which certified, is capable of training and examining NDT Level I and Level II personnel for certification in those methods.

Similarly, the term “Level II” as used elsewhere in this disclosure has been defined by the ASNT as follows: An NDT Level II individual is qualified to set up and calibrate equipment and to interpret and evaluate results with respect to applicable codes, standards, and specifications. The NDT Level II is thoroughly familiar with the scope and limitations of the methods for which qualified and exercises assigned responsibility for on-the-job training and guidance of trainees and NDT Level I personnel. The NDT Level II is able to organize and report the results of NDT.

Returning to Table 1, to attain a DQ=3, the supplier should meet the requirements of DQ=2, and the buyer should examine and certify the supplier's level III by administering a “general, specific, and practical examination at a location other than the supplier's inspection facility.” In one aspect of this embodiment, the general examination can be defined as a written examination which may consist of a minimum of 30 questions relating to fundamentals and principles of the inspection test method. Similarly, the specific examination can be defined as a written examination which may consist of a minimum of 15 questions relating to the specific inspection process specification and acceptance standards. And finally, the practical examination can be defined as a demonstration of proficiency in applying the process specification, including interpreting and evaluating inspection results on one or more samples or production hardware. In another aspect of this embodiment, the practical examination can be conducted with an audit form having at least ten different checkpoint requirements.

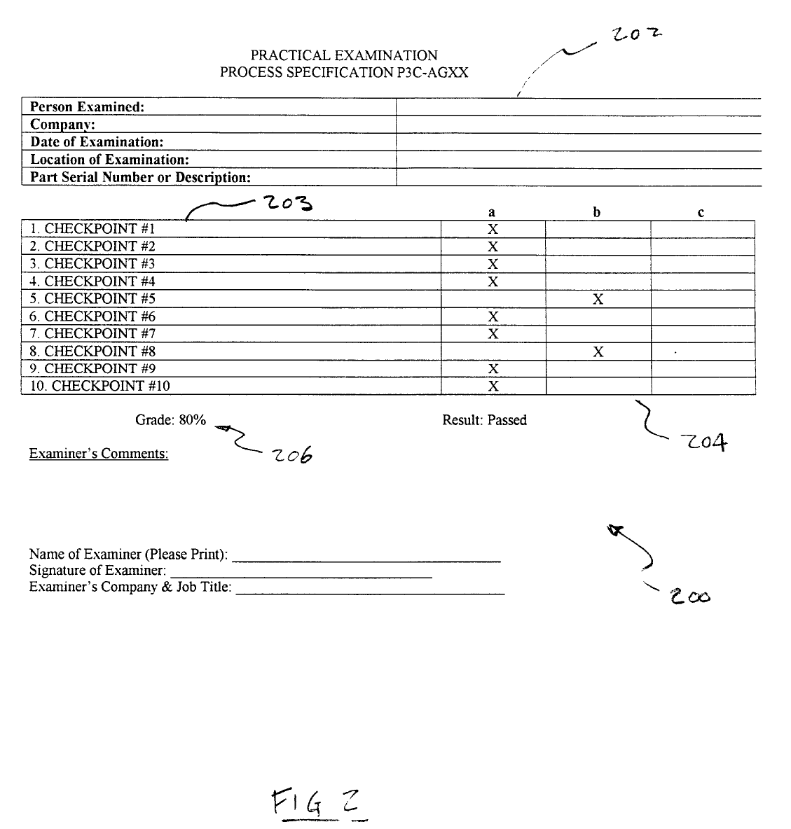

FIG. 2 illustrates an example of a practical examination audit form 200 in accordance with the embodiment discussed above. The practical examination audit form 200 has a pertinent information portion 202, a checkpoint portion 203, and a checkpoint score portion 204. The pertinent information portion 202 contains information about the supplier company and the individual examined, as well as information regarding the component involved. The checkpoints 1-10 represent objective indicia of the applicable process specification. A supplier's performance of the process step associated with each checkpoint can be measured and scored with an A, B or C. A score of A is given when the supplier properly performs the checkpoint. A score of B is given if the checkpoint is performed but a minor detail is omitted or performed incorrectly. A score of C is given if the checkpoint is omitted entirely or performed incorrectly. A practical examination grade portion 206 is computed as the percentage of A scores obtained. For example, if there are ten checkpoints and eight have a score of A and two have a score of B, then the grade is 80%. Any score of C automatically fails the examination and the grade is recorded as zero percent. For this reason, only significant checkpoints should be used in this embodiment. As an option to using the audit form 200 to conduct the practical exam, the practical exam can also be conducted using a computer implemented routine to calculate the supplier's grade.

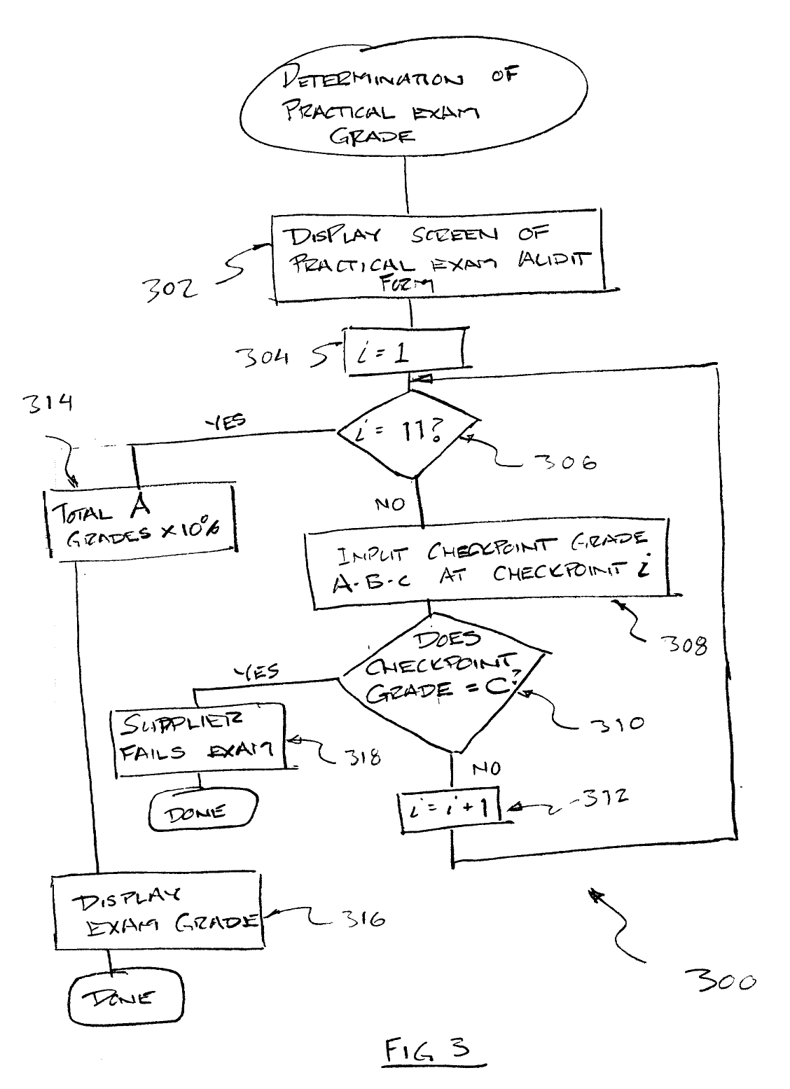

FIG. 3 is a flow diagram of a routine 300 for calculating a supplier's practical exam grade in accordance with an embodiment. In one aspect of this embodiment, the routine 300 can be implemented on a suitable computer system having a display screen and using appropriate computer executable-instructions embedded on a computer-readable medium. In block 302, the routine 300 displays a practical exam screen. In one embodiment, the practical exam screen can resemble the practical examination audit form 200 shown in FIG. 2 having ten checkpoints. In block 304, an initial i value is set to one. Since i will not be equal to 11 in decision block 306, the routine 300 will ask a user (presumably a buyer personnel administering the exam) to input the supplier's grade for checkpoint one in block 308. If the grade for the applicable checkpoint (checkpoint one in this case) is a C, then the routine will indicate that the supplier has failed the exam in block 318, and the routine will be completed. If instead the grade for the applicable checkpoint is a B or better, the routine will proceed to increment i by one in block 312 and repeat blocks 306 through 310 until i is equal to 11. When i equals 11 in block 306, the routine will proceed to block 314 and calculate the supplier's score for the exam by multiplying the number of A grades by a factor of 10. In block 316, the routine can display the supplier's exam grade as a percentage. When a practical examination contains more or less than ten checkpoints, a routine similar to that shown in FIG. 3 is used by adjusting the limits of i and the A grade multiplying factor appropriately.

Attaining a DQ=3 also requires that the buyer review and approve the supplier's quality system using a checklist. The supplier's quality system can be defmed in this embodiment as the supplier's internal procedures and documentation that control the inspection process. The supplier's quality system should be reviewed using a suitable checklist that lists the various requirements imposed on the supplier's quality system and includes a statusing mechanism for each.

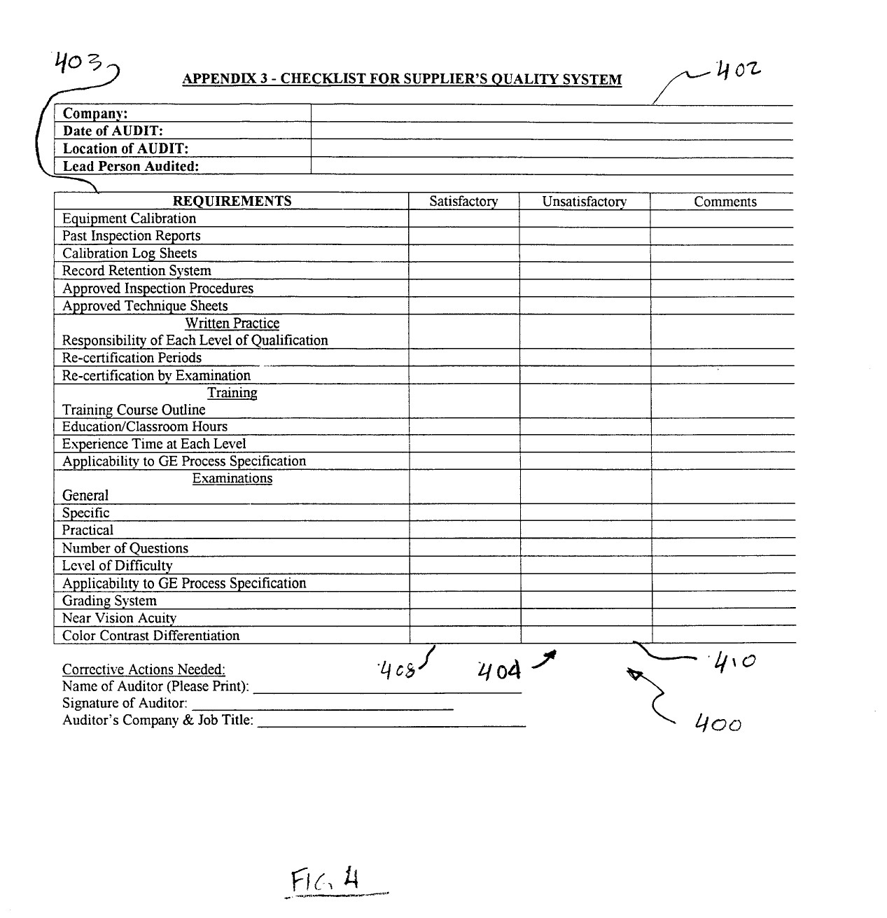

FIG. 4 illustrates a representative checklist 400 that a buyer can use to review and approve a supplier's quality system in accordance with the embodiment discussed above. The checklist 400 has a pertinent information portion 402, a requirements portion 403, and a requirements statusing portion 404. The requirements statusing portion 404 has columns 408 and 410 for assigning either satisfactory or unsatisfactory status, respectively, to the various requirements. The requirements portion 403 should include aspects of the supplier's quality system that will directly affect the quality of the supplier's NDT process. For example, requirements directed to equipment calibration and inspection, written practice, personnel training and periodic proficiency examinations can be included. If a supplier's quality system is unsatisfactory in any respect, then under this embodiment corrective action is required before the supplier can receive a DQ=3 rating. As an option to using the checklist 400 to review and approve the supplier's quality system, the quality system can also be reviewed and approved using a computer routine to implement the checklist functionality.

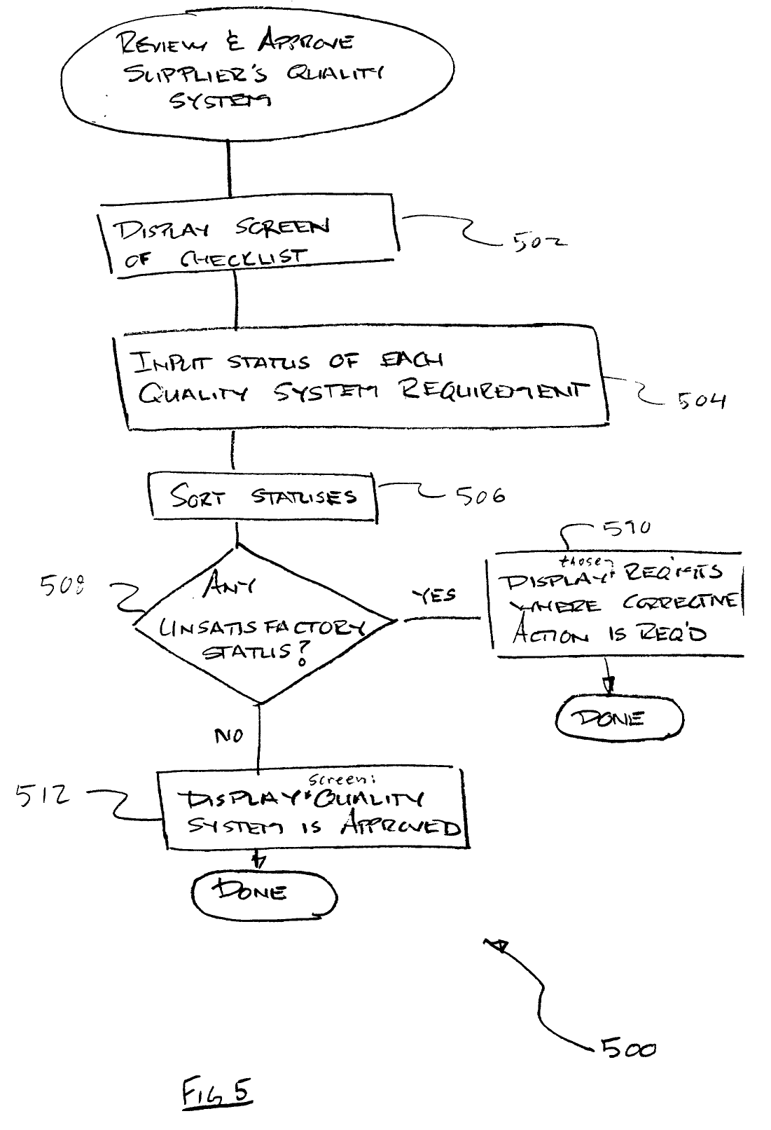

FIG. 5 is a flow diagram of a routine 500 for reviewing and approving a supplier's quality system in accordance with an embodiment. In one aspect of this embodiment, the routine 500 implements a checklist routine on a suitable computer system having a user display screen and using appropriate computer executable-instructions embedded on a computer-readable medium. In block 502, the routine 500 displays a checklist screen. In one embodiment, the checklist screen can resemble the checklist 400 shown in FIG. 4. In block 504, a user (presumably a buyer personnel conducting the review) inputs either a satisfactory or unsatisfactory status for each of the requirements shown on the checklist screen. The requirements are sorted according to their statuses in block 506.

In decision block 508, if the supplier's quality system did not meet some of its requirements and hence had some unsatisfactory statuses, then in block 510 the routine 500 will display a screen indicating those requirements where corrective action is necessary in order for the quality system to be approved. If the quality system satisfactorily met all of its requirements, then in block 512 the routine 500 displays a quality system approval screen. In alternative embodiments, it may be possible to approve a quality system in certain circumstances where one or more of the requirements have an unsatisfactory status.

Returning to Table 1, to attain a DQ=4 the supplier should meet the requirements for a DQ=3, and the buyer should examine and certify the supplier's Level III by administering a general, specific, and practical examination at the supplier's inspection facility. A DQ=5 is attained by meeting the requirements of DQ=4, and additionally certifying the supplier's applicable inspectors by administering a general, specific, and practical examination at the supplier's inspection facility. The “applicable inspectors” would be those inspectors responsible for inspecting the particular parts the buyer procures from the supplier.

As best seen in FIG. 1, after the Degree of Qualification (DQ) has been determined by applying the requirements criteria provided in Table 1, the routine 100 determines the Degree of Audit (DA) in block 104. As mentioned above, the DA is a number on a scale of zero to seven that is based on the level of control used to confirm a supplier's adherence to the buyer's process specification. Higher numbers imply greater oversight of the supplier's process. For all DA levels, the audit shall consist of the same requirements used for the original qualification DQ. The only exception to this requirement is that for audits following a DQ=4, a general, specific and practical examination will be administered to the Level III and one inspector (if applicable) who is chosen at random by the buyer. For DQ values of 2 or less, the DA value shall equal 0. In addition to the foregoing, the requirements for a supplier's inspection process to attain a particular DA rating are shown below in Table 2.

TABLE 2
DA = 0, No audit of the inspection process is conducted.
DA = 1, Buyer conducts an audit at the supplier’s inspection
facility within five (5) years of initial qualification or the last
audit. The audit covers the supplier’s quality system and
proficiency in the inspection process. A checklist is used to
review and approve the supplier’s quality system.
DA = 2, Same requirements as for = 1 except buyer conducts
an audit at the supplier’s inspection facility within three (3)
years of initial qualification or the last audit.
DA = 3, Same requirements as for DA = 1 except buyer
conducts an audit at the supplier’s inspection facility within
one (1) year of initial qualification or the last audit
*DA = 4, In addition to the requirement for DA = 1,
buyer’s certifying agent re-inspects material and compares
results on a sample basis. The sample basis is based on an
established audit plan approved by the cognizant sourcing
quality engineer (SQE). The supplier shall not be aware of the
specific material to be sampled and the re-inspection shall be
performed without knowledge of the supplier’s test results.
*DA = 5, Same requirements as for DA = 4 except buyer,
not buyer’s certifying agent, re-inspects material and compares
results on a sample basis.
*DA = 6, same requirements for DA = 4 Except buyer’s
certifying agent re-inspects all (100%) material.
*DA = 7, Same requirements as for DA = 6 except buyer,
not buyer’s certifying agent, re-inspects all (100%) material.
*Personnel who re-inspect material for DA = 4-7 should be qualified to level II (minimum) in the inspection method. In addition, these inspectors should have 80 hours (minimum) of hands-on experience testing to, or must have inspected Five parts in accordance with, the applicable process specification. If Buyer determines that the inspection of Five of a particular part does not meet the minimum experience requirement, an additional number of parts may be
#specified by Buyer to meet this requirement

In other embodiments, other requirements corresponding to other Degrees of Audit can be established depending upon the audit requirements associated with the particular inspection process or the nature of the components being procured.

The requirements in Table 2 are an objective scale representing increased levels of buyer oversight of the supplier's NDT inspection processes. For example, a supplier will have a DA=0 if no buyer audit of the supplier's NDT inspection processes is conducted. A DA=1 requires, among other things, that the buyer conducts an audit of the supplier's inspection facility within five years of initial qualification or the previous audit. A DA=2 includes the requirements of DA=1 except that now the buyer should conduct the audit at the supplier's inspection facility within three years of initial qualification or the previous audit. Similarly, a DA=3 includes the requirements of DA=1, except the buyer should now conduct the audit at the supplier's inspection facility within one year of the initial qualification or the previous audit.

For a supplier to achieve a level of DA 4 through DA 7, the supplier personnel who perform the inspections must be qualified to a Level II as a minimum in the inspection method. In this context, level II means an inspector who possesses the requisite qualifications for the Level II title as defmed above. In addition, these inspectors should have at least 80 hours of hands-on experience testing to, or have inspected five parts in accordance with, the applicable process specification.

In addition to the foregoing requirements, to achieve a DA=4, the buyer's certifying agent should re-inspect components from the supplier and compare the inspection results to the supplier's inspection results on a sample basis. The supplier shall not be aware of the specific components to be sampled, and the re-inspection should be performed without knowledge of the supplier's test results. To achieve a DA=5, the DA=4 requirements are performed except not by the buyer's certified agent but instead by the buyer itself. A DA=6 is attained when the requirements of DA=4 are performed by the buyer's certifying agent on 100 percent of the components provided by the supplier. Attainment of DA=7 includes the requirements of DA=6 except that 100 percent of the supplier's components are re-inspected not by the buyer's certifying agent, but rather by the buyer itself

Returning to FIG. 1, after the Degree of Audit (DA) has been determined by applying the requirements criteria provided in Table 2, the routine 100 determines the Degree of Reliability (DR) in block 106. As mentioned above, the Degree of Reliability is a number on a scale of zero to six that is based on the level of control exercised by the supplier to perform the inspection, or alternatively, is based on the inherent reliability of the inspection modality. Higher numbers imply more automation of the inspection process, or greater inherent reliability in the inspection methods used. In one aspect of this embodiment, the DR rating can be determined for a particular supplier's inspection process using the requirements and criteria provided in Table 3 below.

TABLE 3
DR = 0, The inspection process requires the inspector to simultaneously
acquire data and analyze data. Some examples include ultrasonic and eddy
current inspections that require manual manipulation of the transducer or
probe.
DR = 1, The inspection process is controlled so that the inspector
only needs to concentrate on analysis of the inspection results. Some
examples include magnetic particle and liquid penetrant techniques where
physical application of the technique happens prior to visual analysis of
the results. Also, ultrasonic and eddy current inspections that have
automated movement of the probe relative to the part to allow the
inspector to focus on the instrument display.
DR = 2, In addition to the requirement for DR = 1, an image of
the inspection data is produced to aid analysis and provide documentation
of the inspection results. Some examples include photographs or video of
all parts inspected by magnetic particle or liquid penetrant inspections,
digital images (C-scan, B-scan, etc.) from automated inspection systems,
or radiographs.
DR = 3, In addition to the requirement for DR = 2, the image or
data set contains a quality indicator that can be used to verify calibration
of the inspection. Some examples include a penetrameter on a radiograph,
pie gage shown on the part during a magnetic particle inspection in a
picture, or calibration response in an ultrasonic or eddy current data
image.
DR = 4, In addition to the requirement for DR = 3, indications
are automatically detected and reported using software approved by the
buyer. The software should correct the inspection data for variations in
the quality indicator used to verify the calibration of the inspection. The
software should automatically identify indications detected during the
inspection and report the indications in a format consistent with the
requirements of the buyer inspection specification.
DR = 5, In addition to the requirement for DR = 3, test results
and data from each part are reviewed by buyer.
DR = 6, In addition to the requirement for DR = 4, test results
and data from each part are reviewed by the buyer.

In other embodiments, other requirements corresponding to other Degrees of Reliability can be established depending on the reliability requirements of the particular inspection process or the nature of the components being procured.

The increasing levels of DR defined in Table 3 are an objective scale representing progressively increasing levels of control exercised by the supplier over the NDT inspection processes used. As in Tables 1 and 2, most of the levels shown in Table 3 require the accomplishment of the previous level in addition to further steps and are self explanatory. For example, a DR=0 is associated with an NDT inspection process that requires the inspector to simultaneously acquire and analyze data, as is often the case with manual inspection techniques. The next level of DR=1 can be achieved by an inspection process that only requires the inspector to concentrate on the analysis of the inspection results. A DR=2 can be achieved by supplementing the analysis with an image of the inspection data to aid analysis and provide documentation of the results. DR=3 additionally requires that the image contain a quality indication that can be used to verify calibration of the inspection process. DR=4 requires, in addition to the requirements for DR=3, that indications are automatically detected and reported using software approved by the buyer. A DR=5 requires, in addition to the DR=3 requirements, that the test results and data from each component be reviewed by the buyer. The highest level of DR=6 is achieved when the automatically detected data and reported test results of DR=4 are reviewed by the buyer.

Returning once again to FIG. 1, after the routine 100 has determined DQ, DA and DR in accordance with the foregoing discussion, the Inspection Quality Rating (IQR) is calculated in block 108 using equation (1) above. As mentioned above, the IQR in this embodiment will be a number from zero to 18. A relatively high IQR number (14-18) implies that the supplier performs NDT inspection practices with substantial adherence to the requirements outlined in Tables 1-3, and hence a buyer can have a relatively high level of confidence in the supplier's reported inspection results. One skilled in the art will appreciate that the number ranges presented above for the DQ, DA, DR, and IQR represent only one embodiment of the method and can vary accordingly depending on the degree of refinement desired or the relative importance of the different terms. One skilled in the art will also appreciate that the criteria for the different DQ, DA, and DR ratings can also vary depending on the relative importance that a buyer places on the different aspects of each.

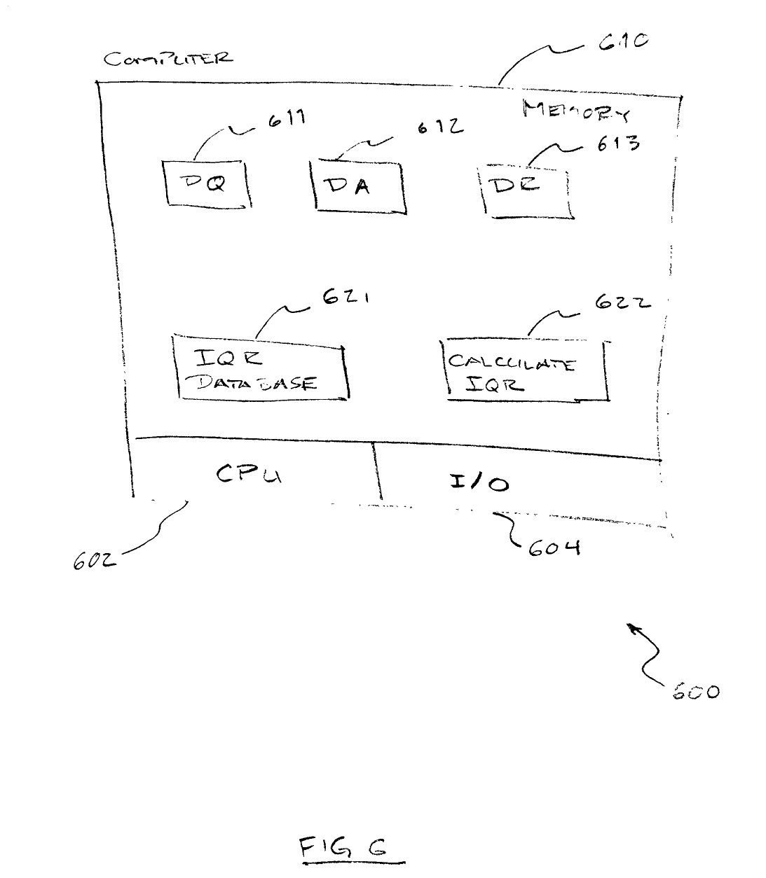

FIG. 6 is a block diagram of a computer system 600 for determining NDT process control area ratings and calculating a corresponding IQR in accordance with the methods described above. The computer system 600 includes a central processing unit 602, input/output devices 604, and a memory 610. The central processing unit 602 can include circuitry for performing computer functions, such as executing software to perform desired calculations and tasks. The input/output devices 604 can include automatic input devices such as a computer-readable media drive, or manual input devices such as a keypad or mouse, for inputting data into the central processing unit 602. The input/output devices 604 can also include output devices coupled to the central processing unit 602, such as a printer or a display screen, for displaying or otherwise outputting data.

The computer memory 602 can include storage media containing computer-executable instructions for performing the various routines described above. For example, the memory 610 can include a DQ component 611, a DA component 612, a DR component 613, and an IQR component 622. The DQ component 611 can contain computer-executable instructions for determining DA in accordance with Table 1 and the routines of FIGS. 3 and 5. Similarly, the DA and DR components 612 and 613 can contain computer-executable instructions for determining DA and DR in accordance with Tables 2 and 3, respectively. The IQR component 622 can contain computer-executable instructions that use the DQ, DA, and DR data to determine the IQR in accordance with Equation (1) or (2) above and the routine of FIG. 1. An IQR database 621 can be used to store the values of DQ, DA, DR, and IQR for different suppliers.

One advantage of using the methods described herein is that they provide the buyer with a consistent and quantitative approach for rating the levels of qualification of a supplier's NDT processes using objective scales. By providing a range of possible ratings, the method provides insight into the extent of the supplier's actual qualifications. In contrast, conventional methods typically determine supplier qualification based solely on subjective application of pass-fail criteria. With these conventional methods, a supplier will either be qualified or not qualified, with no insight provided into the extent of the supplier's actual qualifications.

In addition, the methods described herein also provide a buyer with the ability to specify a unique IQR that is tailored to the particular component or application the buyer wishes to procure. The buyer can further specify a particular level of DQ, DA or DR for a given component or application when that aspect of the component or application is deemed critical by the buyer. Those suppliers capable of providing the component or performing the application can then be readily determined by reference to their IQRs or their individual DQ, DA, and DR ratings.

The DQ, DA, DR and IQR ratings can be used in a number of different ways to qualify a given supplier's NDT process capability. For example, in one embodiment, a buyer could simply establish a minimum IQR rating requirement and compare a potential supplier's IQR to this requirement when desiring to qualify the supplier's NDT processes. In another embodiment, the buyer could establish not only a minimum IQR rating requirement but also minimum DQ, DA, and DR rating requirements. Alternatively, the buyer could establish only minimum DQ, DA, and DR rating requirements and not impose a minimum IQR rating requirement.

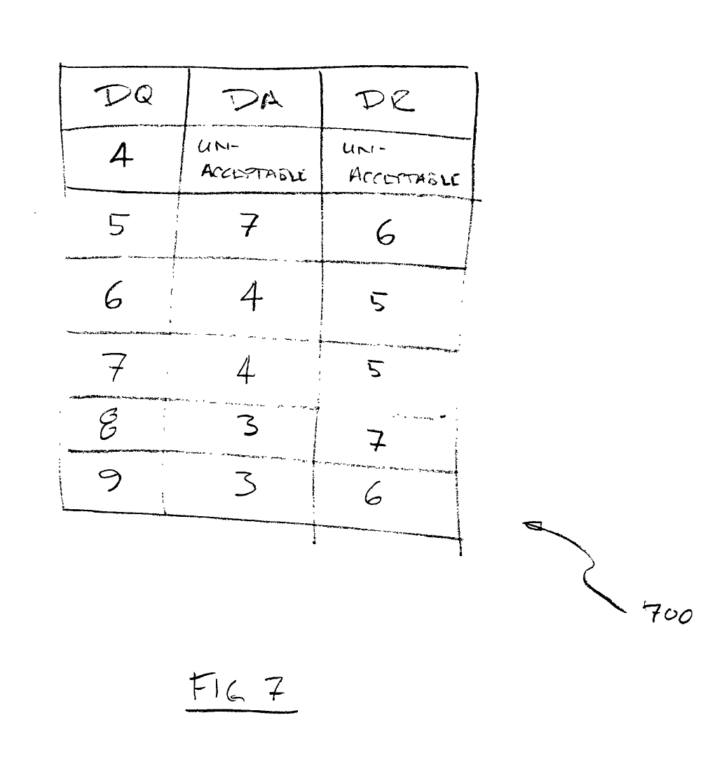

In yet another alternate embodiment, the buyer could establish an array of acceptable combinations of DQ, DA, and DR ratings, and compare a potential suppliers combination of DQ, DA, and DR ratings to these combinations when desiring to qualify the supplier's NDT processes. FIG. 7 illustrates one example of an array 700 of possible acceptable combinations of DQ, DA, and DR. Reference to the combinations shown in FIG. 7 illustrates that the DQ, DA, and DR ratings in this alternate embodiment do not necessarily have to follow a consistent pattern. Further, in this embodiment an acceptable rating in any particular control area is seen to depend on the ratings in the other control areas; and the dependence between ratings does not have to be linear nor proportional.

A further advantage of the methods and systems disclosed herein is that they provide the supplier with the flexibility of determining the most timely and cost-effective approach to achieving and maintaining the level of IQR that the supplier desires. For example, if a supplier wanted to decrease its DQ level a certain amount because of the costs associated with maintaining it, the supplier could do so by increasing either its DA or DR level an equivalent amount, depending on which was most cost effective, and the supplier's overall IQR would not change.

Although various criteria and requirements have been disclosed above in certain embodiments with reference to the DQ, DA and DR, those of skill in the art will recognize that other criteria and requirements can be established for quantitatively qualifying a supplier's NDT processes depending on the relative importance of the various aspects to the buyer. Similarly, while certain examples of checkpoint examination audit forms and supplier checklists have also been discussed above, those of relevant skill in the art will also appreciate that other forms of these embodiments can be developed without departing from the intent or scope of the method and system described herein.

The above description and illustrated embodiments of the method and system for supplier qualification is not intended to be exhaustive or limit the invention to the precise form disclosed. While specific embodiments of, and examples for, the method and system are described herein for illustrative purposes, various equivalent modifications are possible within the scope of the invention, as those skilled in the art will recognize. The teachings of the embodiments provided herein for applying objective indicia to quantitative qualification of supplier inspection processes is not limited to the three factors of DQ, DA, and DR presented herein, and can include additional factors or be applied without some of the factors discussed herein. Accordingly, the scope of the present invention is not limited except by the appended claims.

I claim:

1. A method in a computer system for qualifying an inspection process, the inspection process including two or more inspection process control areas, the method comprising:
providing a first rating of a first inspection process control area;
providing a second rating of a second inspection process control area;
adding the first rating to the second rating to produce an inspection quality rating; and
qualifying the inspection process when the inspection quality rating is greater than or equal to a pre-selected minimum inspection quality rating.

2. A computer based method for qualifying an inspection process, the inspection process including two or more inspection process control areas, the method comprising:
providing a first rating of a first inspection process control area;
providing a second rating of a second inspection process control area; and
analyzing the first and second ratings.

3. The method of claim 2 further comprising:
qualifying the inspection process based on the analysis of the first and second ratings.

4. The method of claim 2 wherein analyzing the first and second ratings comprises adding the first rating to the second rating.

5. The method of claim 2 wherein analyzing the first and second ratings comprises comparing at least one of the ratings to a minimum rating.

6. The method of claim 2 wherein analyzing the first and second ratings comprises comparing a combination of the first and second ratings to an array of acceptable rating combinations.

7. The method of claim 2 wherein the inspection process includes three inspection process control areas related to non-destructive test inspections, and wherein:
providing the first rating comprises providing a rating of an inspection process control area related to qualifications of the personnel conducting the inspection process;
providing the second rating comprises providing a rating of an inspection process control area related to audits of the inspection process; and wherein the method further comprises:
providing a third rating of a third inspection process control area, wherein the third inspection process control area is related to the reliability of techniques used in the inspection process; and
analyzing the third rating in conjunction with the first and second rating.

8. A method in a computer system for qualifying an inspection process, the inspection process including one or more separable inspection process control areas, the method comprising:
providing a quantitative system for rating one or more of the inspection process control areas on a scale having at least three different ratings, the ratings based on the performance of selected requirements related to the process control area.

9. The method of claim 8 wherein the quantitative system is provided for rating at least two separable inspection process control areas, the method further comprising:
providing a first rating of a first inspection process control area;
providing a second rating of a second inspection process control area; and
qualifying the inspection process based on the first and second ratings.

10. A method for qualifying an inspection process, the inspection process including two or more inspection process control areas, the method comprising:
determining a first rating of a first inspection process control area;
determining a second rating of a second inspection process control area;
analyzing the first and second ratings; and
qualifying the inspection process based on the analysis of the first and second ratings.

11. A method for controlling an inspection process qualification level, the inspection process including one or more ratable inspection process control areas, the method comprising:
specifying an overall inspection quality rating, wherein the inspection quality rating is comprised of a first inspection process control area rating and a second inspection process control area rating.

12. A method for controlling an inspection process qualification level, the inspection process including one or more ratable inspection process control areas, the method comprising:
specifying an acceptable combination of inspection process control area ratings, wherein the acceptable combination is comprised of a first inspection process control area rating and a second inspection process control area rating.

13. A method for controlling an inspection process qualification level of a supplier, the inspection process qualification level corresponding to an inspection quality rating of the supplier, wherein the inspection quality rating is comprised of a first inspection process control area rating and a second inspection process control area rating, the method comprising:
adjusting the first or second inspection process control area ratings.

14. The method of claim 13 wherein adjusting the first or second inspection process control area rating comprises lowering the first or second control area rating when the inspection quality rating of the supplier exceeds a specified minimum inspection quality rating.

15. The method of claim 13 wherein adjusting the first or second inspection process control area rating comprises lowering one of the inspection process control area ratings and raising one of the inspection quality control area ratings when the inspection quality rating of the supplier meets or exceeds a specified minimum inspection quality rating.

16. A computer system for qualifying an inspection process control area, the computer system comprising:
a control area rating component containing computer-executable instructions for determining an inspection process control area rating;
a central processing unit for executing the computer-executable instructions for determining the inspection process control area rating; and
an output device for displaying the inspection process control area rating.

17. The computer system of claim 16 wherein the control area rating component is a first control area rating component and wherein the computer system further comprises:
a second control area rating component containing computer-executable instructions for determining a second inspection process control area rating;
a third control area rating component containing computer-executable instructions for determining a third inspection process control area rating; and
an inspection quality rating component containing computer-executable instructions for determining an overall inspection quality rating, wherein the inspection quality rating is comprised of the first, second, and third control area ratings.

18. A computer-readable medium whose contents cause a computer system to provide an inspection quality rating for an inspection process, the inspection process including one or more ratable inspection process control areas, by a method comprising:
determining a first control area rating for a first inspection process control area;
determining a second control area rating for a second inspection process control area; and
determining the inspection quality rating based on an analysis of the first and second control area ratings.

19. A computer-readable medium whose contents cause a computer system to provide a grade for a practical examination of an inspection process, the inspection process including a predetermined number of gradable checkpoints corresponding to selected aspects of the inspection process, by a method comprising:
receiving a checkpoint grade for each of the gradable checkpoints;
comparing each of the checkpoint grades to a pre-selected minimum grade;
optionally indicating a failing grade if any of the checkpoint grades do not exceed the pre-selected minimum grade; and
optionally indicating a passing grade based on the checkpoint grades if all of the checkpoint grades exceed the pre-selected minimum grade.

20. The computer-readable medium of claim 19 wherein the checkpoint grade optionally comprises an A, B, or C grade depending on a performance of a portion of the practical exam corresponding to the checkpoint, wherein A is the highest grade, B is the next-highest grade, and wherein the pre-selected minimum grade is the C grade.

21. A display description for permitting a computer display device to provide an inspection quality rating for an inspection process, the inspection process including one or more ratable inspection process control areas, the display description comprising:
a first inspection process control area rating portion for identifying a first control area rating;
a second inspection process control area rating portion for identifying a second control area rating; and
an inspection quality rating portion for identifying an inspection quality rating based on the first and second control area ratings.

22. A computer system for qualifying an inspection process, the inspection process including two or more inspection process control areas, comprising:
means for providing a first rating of a first inspection process control area;
means for providing a second rating of a second inspection process control area; and
means for analyzing the first and second ratings.
